(19) United States
(12) Patent Application Publication
(10) Pub. No.: US 2023/0022737 A1
(43) Pub. Date: Jan. 26, 2023

(54) GENERATION SUPPORT APPARATUS, GENERATION SUPPORT METHOD, AND GENERATION SUPPORT PROGRAM

(71) Applicant: Hitachi, Ltd., Tokyo (JP)

(72) Inventor: Souichi TAKASHIGE, Tokyo (JP)

(73) Assignee: Hitachi, Ltd., Tokyo (JP)

(21) Appl. No.: 17/691,825

(22) Filed: Mar. 10, 2022

(30) Foreign Application Priority Data
Jul. 21, 2021 (JP) 2021-120632

(51) Int. Cl. G06N 5/02

(52) U.S. Cl. CPC G06N 5/022

(57) ABSTRACT

Provided is a generation support apparatus including: a storage device that stores component tables for storing a change history of a plurality of component groups for a machine learning model, and a model component management table for storing versions for the plurality of component groups; a model change recorder that inputs configuration information on an updated first machine learning model, adds the change history to the component tables, and records a version of an updated component group in the model component management table; and a derived model parameter synthesizer that generates a model parameter including a component corresponding to a version of an updated component group of the first machine learning model, for a second machine learning model including a component group of the same version as a component group before updating of the first machine learning model.

### BACKGROUND OF THE INVENTION

### 1. Field of the Invention

The present invention relates to a technology for supporting generation of a related machine learning model in a case where a machine learning model is changed.

### 2. Description of the Related Art

The machine learning model is used to monitor abnormalities of a plurality of devices in a factory, a power facility, or the like. In order to monitor the abnormalities of the plurality of devices, the machine learning model tuned for each device is required.

For example, when a certain algorithm is changed, it is necessary to individually tune or learn parameters of the machine learning model for each device.

For example, a technology of recording and managing a history of a change point (change in data, parameter, and feature) or the like of such a machine learning model is known (see, for example, U.S. Pat. No. 9,996,804).

### SUMMARY OF THE INVENTION

As described above, in order to monitor the abnormalities of the plurality of devices, the machine learning model tuned for each device is required, but most of the algorithm can be commonly used among the plurality of devices in many cases.

In such a case, in a case where the algorithm of the machine learning model of a certain device is changed, it is preferable to specify the related machine learning model and generate the machine learning model.

For example, in the technology disclosed in U.S. Pat. No. 9,996,804, a past machine learning model can be grasped from a history of a certain machine learning model, but it is difficult to specify a related machine learning model.

The present invention has been made in view of the above circumstances, and an object of the present invention is to provide a technology capable of supporting generation of a related machine learning model when a certain machine learning model is changed.

In order to achieve the above object, the generation support apparatus according to one viewpoint is a generation support apparatus that generates configuration information for configuring a machine learning model, and includes: a storage that stores a plurality of pieces of component information for storing a change history for each of component groups that are groups of a plurality of components for the machine learning model, and component management information for storing versions for the plurality of component groups constituting the machine learning model; a recorder that inputs the configuration information on an updated first machine learning model, adds the change history to the component information based on the configuration information, and records a version of a component group of the updated first machine learning model in the component management information; and a configuration information generator that generates configuration information including a component corresponding to a version of an updated component group of the updated first machine learning model, for a second machine learning model including a component group of a same version as a component group before updating of the first machine learning model.

According to the present invention, when a certain machine learning model is changed, it is possible to support generation of a related machine learning model.

### BRIEF DESCRIPTION OF THE DRAWINGS

FIG. 1 is an overall configuration diagram of a generation support apparatus according to an embodiment;

FIG. 2 is a hardware configuration diagram of the generation support apparatus according to the embodiment;

FIG. 3 is a flowchart of machine learning model generation support processing according to the embodiment;

FIG. 4 is a flowchart of component update processing according to the embodiment;

FIG. 5 is a flowchart of derived model parameter synthesis processing according to the embodiment; and

FIG. 6 is a diagram illustrating an example of generation of a machine learning model and a specific example of the machine learning model generation support processing in the embodiment.

### DESCRIPTION OF THE PREFERRED EMBODIMENTS

An embodiment will be described with reference to the drawings. Note that the embodiment described below does not limit the invention according to the claims, and all elements and combinations thereof described in the embodiment are not necessarily essential to the solution of the invention.

In the following description, information will be sometimes described with an expression of an “AAA table”, but the information may be expressed with any data structure. That is, the “AAA table” can be referred to as “AAA information” in order to indicate that the information does not depend on the data structure.

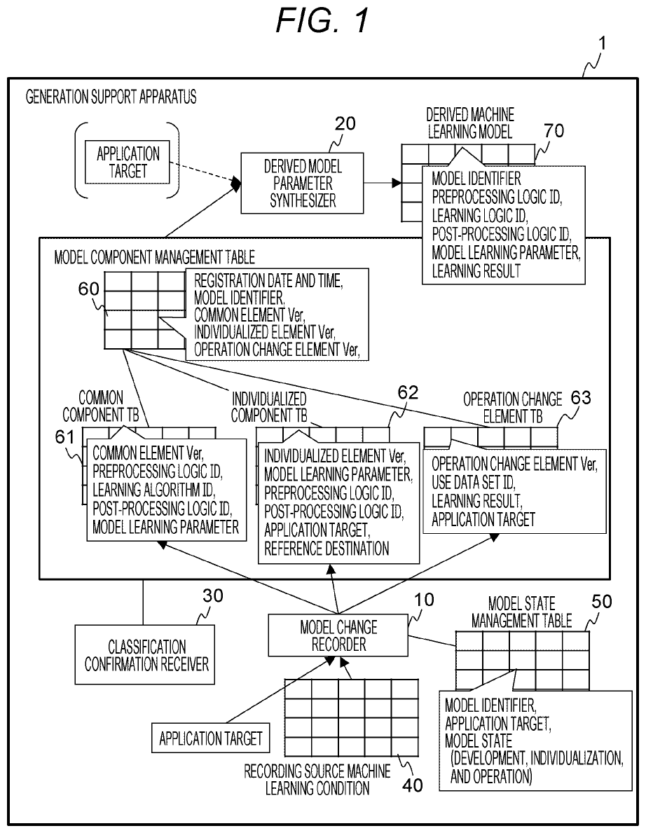

FIG. 1 is an overall configuration diagram of a generation support apparatus according to the embodiment.

A generation support apparatus 1 includes: a model change recorder 10 as an example of a recorder, a derived model parameter synthesizer 20 as an example of a configuration information generator, a classification confirmation receiver 30, a recording source machine learning condition 40, a model state management table 50 as an example of state management information, a model component management table 60 as an example of component management information, a common component table (TB) 61 as an example of component information, an individualized component table (TB) 62 as an example of the component information, an operation change element table (TB) 63 as an example of learning element information, and a derived machine learning model 70.

The model change recorder 10 performs processing of recording a value of each item (each element) of the recording source machine learning condition 40 in the model component management table 60, the common component table 61, the individualized component table 62, and the operation change element table 63.

The derived model parameter synthesizer 20 uses the model component management table 60, the common component table 61, the individualized component table 62, and the operation change element table 63, to generate configuration information (model parameters) of a machine learning model reflecting changed elements, for a newly changed and recorded machine learning model (a first machine learning model) and a machine learning model (a second machine learning model) corresponding to a common component, an individualized component, or an operation change element, and generates a machine learning model based on the configuration information. Note that the derived model parameter synthesizer 20 may receive designation of an application target for generating the machine learning model, generate the configuration information of only the machine learning model for the application target for which the designation has been received, and generate the machine learning model based on the configuration information.

The classification confirmation receiver 30 displays contents recorded in the model component management table 60, the common component table 61, the individualized component table 62, and the operation change element table 63 by the model change recorder 10, receives an instruction from a user regarding confirmation of a table of a recording destination of a value of each item of the recording source machine learning condition 40, change of the table of the recording destination, and the like, and performs processing such as determination of the recording destination, change of the recording destination, and the like based on the instruction. Note that the classification confirmation receiver 30 may not be provided when the designation from the user is not received.

The recording source machine learning condition 40 includes learning conditions such as the configuration information of an updated machine learning model that is a recording source and a data set used for learning, and specifically includes information of each item managed in the common component table 61, the individualized component table 62, and the operation change element table 63. The recording source machine learning condition 40 may be acquired from, for example, a system that manages an editing history or the like of the machine learning model.

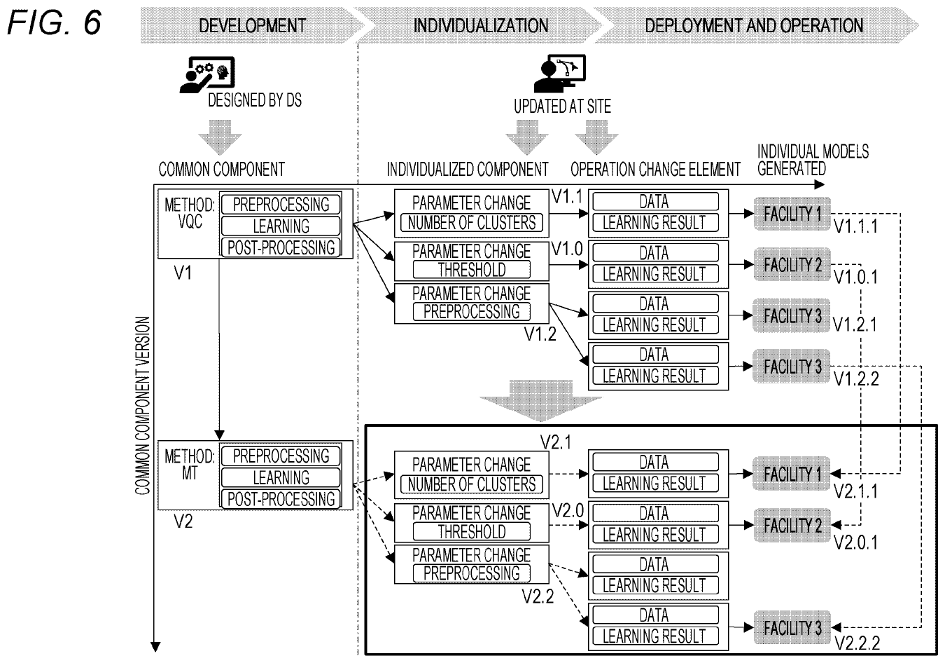

The model state management table 50 stores a record corresponding to each machine learning model. The record of the model state management table 50 stores items of a model identifier, the application target, and a model state. In the item of the model identifier, an identifier (the model identifier) for identifying the machine learning model corresponding to the record is stored. In the item of the application target, the application target of the machine learning model corresponding to the record, for example, an identifier of a facility or the like to be subjected to abnormality detection by the machine learning model is stored. In the item of the model state, an application state for the machine learning model corresponding to the record is stored. Examples of the application state include a state (a development state) in which a common configuration of the machine learning model is developed by a data scientist (DS), a state (an individualized state) in which the machine learning model is tuned in accordance with an individual facility or the like, and a state (an operation state) in which the machine learning model is deployed and actually operated, as illustrated in FIG. 6 to be described later.

The model component management table 60 stores a record corresponding to each machine learning model. Note that the model component management table 60 may store a plurality of records for the same machine learning model. The record of the model component management table 60 includes items of registration date and time, the model identifier, a common element Ver, an individualized element Ver, and an operation change element Ver. In the item of the registration date and time, date and time when the record has been stored is stored. In the item of the model identifier, the model identifier of the machine learning model corresponding to the record is stored. In the item of the common element Ver, a version of the common component (common component group: component group) constituting the machine learning model corresponding to the record is stored. In the item of the individualized element Ver, a version of the individualized component (individualized component group: component group) constituting the machine learning model corresponding to the record is stored. In the item of the operation change element Ver, a version of the component (learning element: operation change element group) to be changed in operation of the machine learning model corresponding to the record is stored.

The common component table 61 is a table for managing a change history of the common component constituting the machine learning model, and stores a record corresponding to each version of the common component. The common component includes a component having a high tendency to be determined in a development stage of the machine learning model. The record of the common component table 61 includes items of the common element Ver, a preprocessing logic ID, a learning algorithm ID, a post-processing logic ID, and a model learning parameter.

In the item of the common element Ver, the version of the common component corresponding to the record is stored. In the item of the preprocessing logic ID, an identifier (the preprocessing logic ID) of the preprocessing logic constituting the common component of the version corresponding to the record is stored. In the item of the learning algorithm ID, an identifier (the learning algorithm ID) of the learning algorithm constituting the common component of the version corresponding to the record is stored. In the item of the post-processing logic ID, an identifier (the post-processing logic ID) of the post-processing logic constituting the common component of the version corresponding to the record is stored. In the item of the model learning parameter, the model learning parameter constituting the common component of the version corresponding to the record is stored.

The individualized component table 62 is a table for managing a history of the individualized component constituting the machine learning model, and stores a record corresponding to each version of the individualized component. The individualized component includes a component that may be determined at a stage of individualizing the machine learning model according to the application target. Note that the common component and the individualized component may include the same components. The record of the individualized component table 62 includes items of the individualized element Ver, the model learning parameter, the preprocessing logic ID, the post-processing logic ID, the application target, and a reference destination.

In the item of the individualized element Ver, the version of the individualized component corresponding to the record is stored. In the item of the model learning parameter, the model learning parameter constituting the individualized component of the version corresponding to the record is stored. In the item of the preprocessing logic ID, the preprocessing logic ID of the preprocessing logic constituting the individualized component of the version corresponding to the record is stored. In the item of the post-processing logic ID, the post-processing logic ID of the post-processing logic constituting the individualized component of the version corresponding to the record is stored. In the item of the application target, an identifier of the application target of the machine learning model constituted by the individualized component corresponding to the record is stored. In the item of the reference destination, information indicating another record to be referred to as a value of the individualized component of the version corresponding to the record is stored. Note that in a case where the record of the reference destination is set in the item of the reference destination, the value of the item in which the value in the record is not set is the value of the corresponding item of the record of the reference destination or the value of the corresponding item of the record of the reference destination further connected via the reference destination. According to the item of the reference destination, a value of an item of a specific record can be commonly used for a related group of application targets.

The operation change element table 63 is a table for managing a history of the operation change element related to learning of the machine learning model, and stores a record corresponding to each version of the operation change element. The operation change element includes an element (the learning element) that may be used in an operation stage of the machine learning model. The record of the operation change element table 63 includes items of the operation change element Ver, a use data set ID, a learning result, and the application target.

In the item of the operation change element Ver, the version of the operation change element corresponding to the record is stored. In the item of the use data set ID, an identifier (the use data set ID) of the use data set constituting the operation change element of the version corresponding to the record is stored. The use data set is a data set used for the learning of the machine learning model. In the item of the learning result, a learning result at the time of learning the machine learning model using the use data set corresponding to the record is stored. In the item of the application target, the identifier of the application target to which the operation change element corresponding to the record is applied is stored.

The derived machine learning model 70 includes a generated machine learning model (derived machine learning model) and information (model parameters) on the configuration and learning of the derived machine learning model. The model parameter includes the model identifier, the preprocessing logic ID, the learning algorithm ID, the post-processing logic ID, the model learning parameter, and the learning result.

The model identifier is a model identifier for identifying the derived machine learning model. The preprocessing logic ID is a preprocessing logic ID of the preprocessing logic constituting the derived machine learning model. The learning algorithm ID is a learning algorithm ID of the learning algorithm constituting the derived machine learning model. The post-processing logic ID is a post-processing logic ID of the post-processing logic constituting the derived machine learning model. The model learning parameter is a model learning parameter used in the derived machine learning model. The learning result is a result of learning the derived machine learning model using the corresponding use data set.

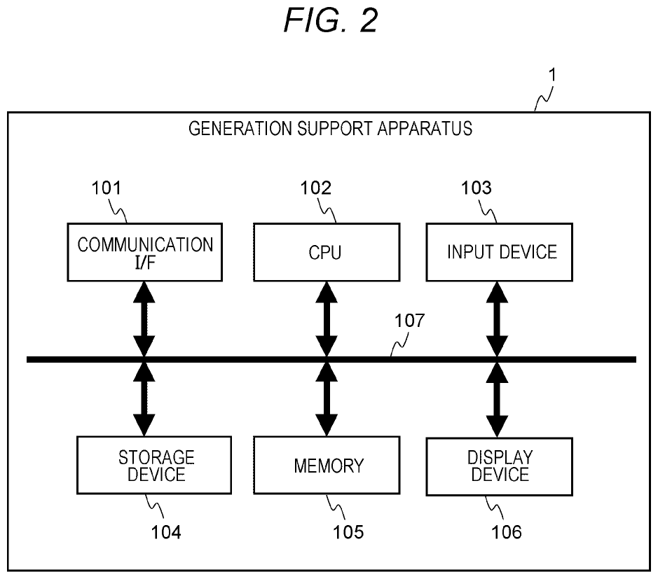

FIG. 2 is a hardware configuration diagram of the generation support apparatus according to the embodiment.

The generation support apparatus 1 includes, for example, a computer such as a personal computer (PC) or a server. The generation support apparatus 1 includes a communication interface (I/F) 101, a central processing unit (CPU) 102, an input device 103, a storage device 104 as an example of a storage, a memory 105, and a display device 106.

The communication interface 101 is, for example, an interface such as a wired LAN card or a wireless LAN card, and communicates with other devices via a network.

The CPU 102 executes various processes according to a program stored in the memory 105 and/or the storage device 104. In the present embodiment, the CPU 102 executes a generation support program to be described later, thereby configuring the model change recorder 10, the derived model parameter synthesizer 20, and the classification confirmation receiver 30.

The memory 105 is, for example, a random access memory (RAM), and stores the program executed by the CPU 102 and necessary information.

The storage device 104 is, for example, a hard disk, a flash memory, or the like, and stores a program (for example, the generation support program) executed by the CPU 102, various logics constituting the machine learning model, data (for example, the use data set used for the learning of the machine learning model) used by the CPU 102, and the like. In the present embodiment, the storage device 104 stores the recording source machine learning condition 40, the model state management table 50, the model component management table 60, the common component table 61, the individualized component table 62, the operation change element table 63, and the derived machine learning model 70.

The input device 103 is, for example, a mouse, a keyboard, or the like, and receives an input of information by the user of the generation support apparatus 1. The display device 106 is, for example, a display, and displays and outputs various types of information.

Next, machine learning model generation support processing will be described.

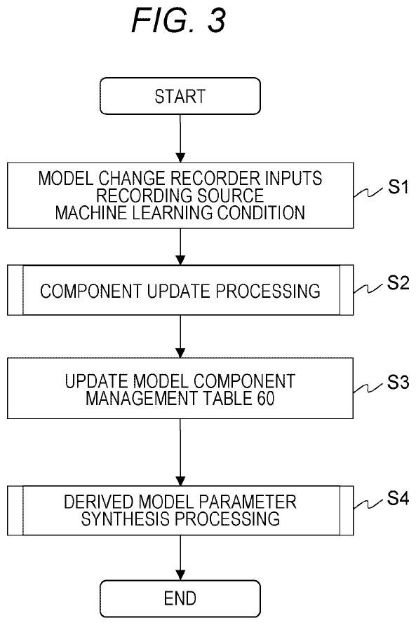

FIG. 3 is a flowchart of the machine learning model generation support processing according to the embodiment.

The model change recorder 10 inputs the recording source machine learning condition 40 (Step S1), and executes component update processing (Step S2).

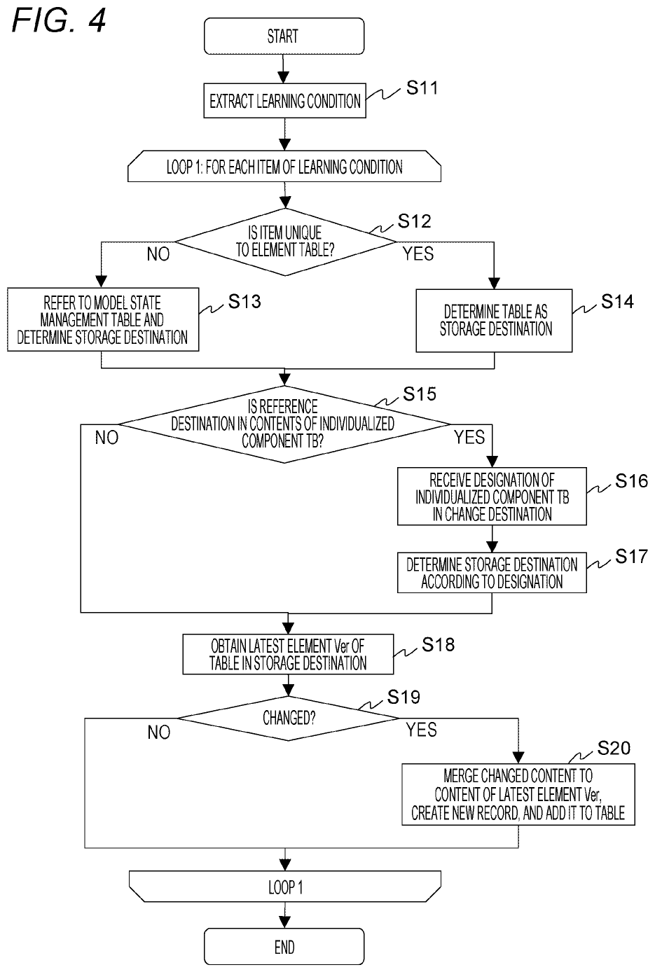

In the component update processing, the model change recorder 10 refers to the record of the model state management table 50 by using the model identifier (a target model identifier) of the machine learning model corresponding to the recording source machine learning condition 40, specifies the element table to record each item of the recording source machine learning condition 40 based on the content of the record, and when there is a change, the model change recorder 10 adds a new record to the specified element table, and records new version information and the contents of the item of the recording source machine learning condition 40 in the record. Note that the component update processing will be described later in more detail with reference to FIG. 4.

Subsequently, the model change recorder 10 acquires the latest record corresponding to the same model identifier as the target model identifier from the model component management table 60, extracts a change point by comparing with the items of the recording source machine learning condition 40, duplicates the latest record, and updates the version information of the changed element table of the record to changed version information (Step S3).

Subsequently, the derived model parameter synthesizer 20 performs derived model parameter synthesis processing (Step S4).

In the derived model parameter synthesis processing, the derived model parameter synthesizer 20 extracts a record including the version of the common component, the individualized component, and the operation change element before change of the changed machine learning model from the model component management table 60, and synthesizes the model parameter (the configuration information) of the derived machine learning model based on the contents of the common component, the individualized component, and the operation change element of the changed version and the contents of the element referred to by the extracted record. Furthermore, the derived model parameter synthesizer 20 generates the derived machine learning model based on the model parameter, and performs learning on the generated derived machine learning model.

Next, details of the component update processing (Step S2) will be described.

FIG. 4 is a flowchart of the component update processing according to the embodiment.

In the component update processing, the model change recorder 10 extracts the value of each item from the recording source machine learning condition 40 (also simply referred to as the learning conditions) (Step S11).

Subsequently, the model change recorder 10 performs processing of a loop 1 (Steps S12 to S20) as a processing target for each item of the learning condition. Here, an item to be processed is referred to as a target item.

First, the model change recorder 10 determines whether the target item is an item unique to any element table (common component table 61, individualized component table 62, operation change element table 63) (Step S12).

As a result, if the target item is not an item unique to the element table (Step S12: No), the model change recorder 10 refers to the record corresponding to the model identifier of the machine learning model corresponding to the learning condition of the model state management table 50, acquires the value of the item in the model state of the record, determines the element table corresponding to the value of the item in the model state as a storage destination (Step S13), and advances the processing to Step S15.

On the other hand, if the target item is the item unique to the element table (Step S12: Yes), the model change recorder 10 determines the element table in which the target item is a unique item as the storage destination (Step S14), and advances the processing to Step S15.

In Step S15, the model change recorder 10 determines whether the storage destination of the target item is the individualized component table 62 and the reference destination is designated in the record of the latest version corresponding to the application target of the learning condition.

As a result, if the reference destination is not designated (Step S15: No), the model change recorder 10 advances the processing to Step S18.

On the other hand, if the reference destination is designated (Step S15: No), the model change recorder 10 receives from the user designation of whether to change the content of the record of a reference source or change the content of the record of the reference destination (Step S16). Note that if the value of the item is not set in the record of the reference destination, the record in which the item is set is specified by sequentially tracing the reference destination of each record until the record in which the value of the item is set is reached. Further, in Step S16, which content of the record is to be changed may be determined according to a predetermined processing instead of the designation by the user.

Subsequently, the model change recorder 10 determines the storage destination of the target item according to the designation of the user (Step S17), and advances the processing to Step S18.

In Step S18, the model change recorder 10 acquires the latest element version of the element table in the storage destination.

Subsequently, the model change recorder 10 determines whether the item of the learning condition is changed from the content of the record corresponding to the latest version of the element table of the storage destination (Step S19), and if the item of the learning condition is not changed (Step S19: No), the model change recorder 10 terminates the processing for the target item. On the other hand, if the item of the learning condition is changed (Step S19: Yes), the model change recorder 10 merges the changed content of the target item to the content of the record corresponding to the latest version, creates a new record having the latest version, adds the record to the element table of the storage destination (Step S20), and terminates the processing for the target item.

Subsequently, the model change recorder 10 performs the processing of the loop 1 (Steps S12 to S20) with each item as the processing target, and ends the component update processing when the processing of the loop 1 is ended with all the items as the processing target.

Next, details of the derived model parameter synthesis processing (Step S4) will be described.

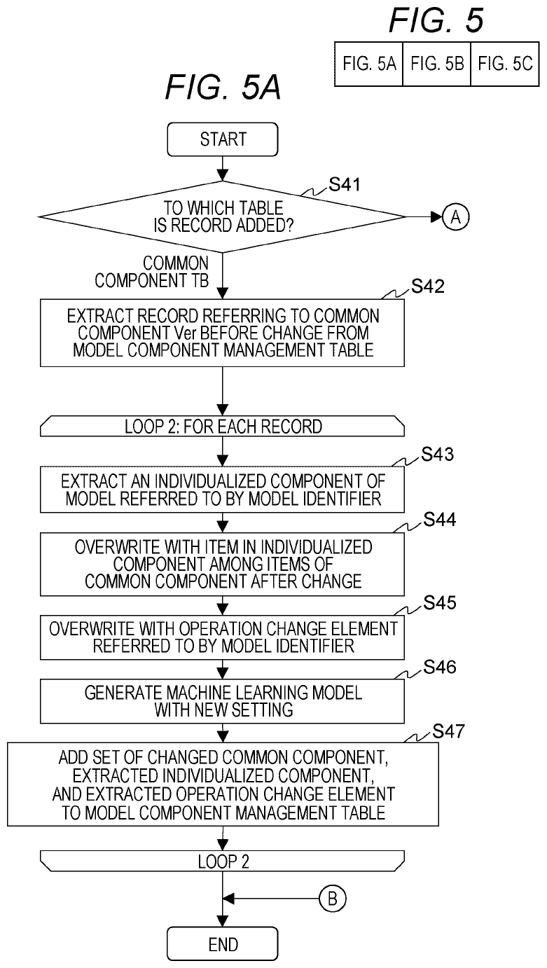

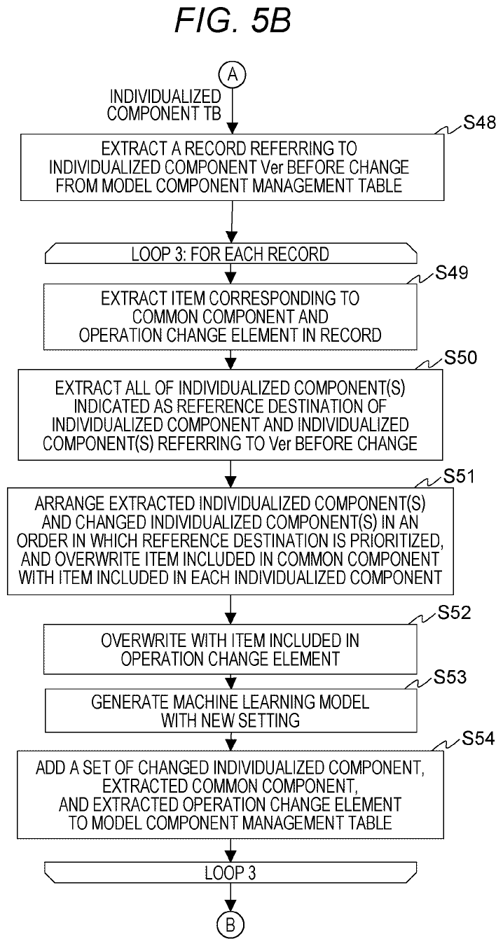

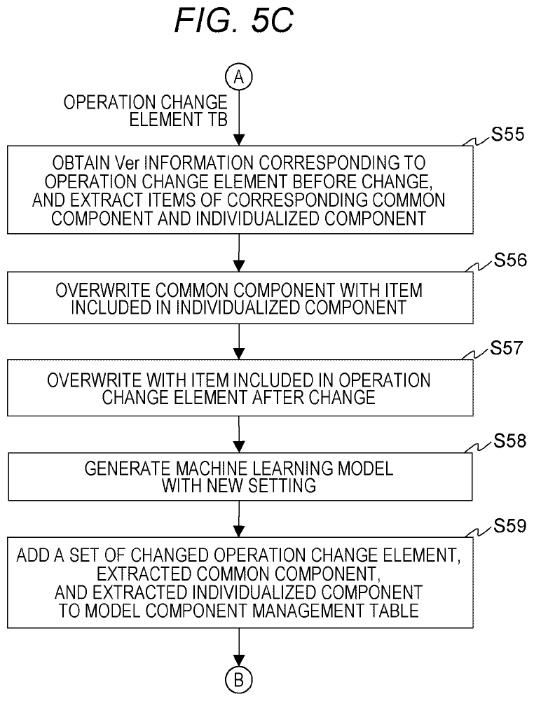

FIG. 5 is a flowchart of the derived model parameter synthesis processing according to the embodiment.

In the derived model parameter synthesis processing, the derived model parameter synthesizer 20 determines to which element table the record has been added in the component update processing (Step S41). As a result, the derived model parameter synthesizer 20 performs the processing of Steps S42 to S47 when the record has been added to the common component table 61 (Step S41: common component TB), performs the processing of Steps S48 to S54 when the record has been added to the individualized component table 62 (Step S41: individualized component TB), and performs the processing of Steps S55 to S59 when the record has been added to the operation change element table 63 (Step S41: operation change element TB). Note that, when the record has been added to the plurality of element tables, the processing corresponding to the common component table 61, the individualized component table 62, and the operation change element table 63 is performed in this order with respect to the plurality of element tables to which the record has been added.

When the record has been added to the common component table 61 (Step S41: common component TB), the derived model parameter synthesizer 20 extracts a record referring to the version of the common component before change from the model component management table 60 (Step S42).

Subsequently, the derived model parameter synthesizer 20 performs processing of a loop 2 (Steps S43 to S47) with each extracted record as the processing target. Here, in the description of the processing of the loop, a record to be processed is referred to as the target record.

First, the derived model parameter synthesizer 20 specifies the version of the individualized component of the target record, and extracts a record (an individualized component record) of a corresponding version of the individualized component table 62 (Step S43).

Subsequently, the derived model parameter synthesizer 20 adds the value of each item of the changed record of the common component table 61 to setting (configuration information: model parameter) of the machine learning model, and overwrites the item common to the individualized component record among the items with the value of the individualized component record (Step S44).

Subsequently, the derived model parameter synthesizer 20 specifies the version of the operation change element of the target record, refers to the record (operation change element record) of a corresponding version of the operation change element table 63, adds the value of the record to the model parameter of the machine learning model, and at that time, overwrites the common item with the value of the operation change element record (Step S45).

Subsequently, the derived model parameter synthesizer 20 generates the machine learning model (derived machine learning model) according to the model parameter of the machine learning model, and performs machine learning on the generated machine learning model using the set use data set, to add the learning result to the model parameter of the machine learning model (Step S46).

Subsequently, the derived model parameter synthesizer 20 adds a record of a set of the version of the common component after change, the version of the extracted individualized component record, and the version of the extracted operation change element record to the model component management table 60 (Step S47).

Subsequently, the model change recorder 10 performs the processing of the loop 2 (Steps S43 to S47) with each record as the processing target, and ends the derived model parameter synthesis processing when the processing of the loop 2 is ended with all the records as the processing target.

When the record has been added to the individualized component table 62 (Step S41: individualized component TB), the derived model parameter synthesizer 20 extracts a record referring to the version of the individualized component before change from the model component management table 60 (Step S48).

Subsequently, the derived model parameter synthesizer 20 performs processing of a loop 3 (Steps S49 to S54) with each extracted record as the processing target. Here, in the description of the processing of the loop, a record to be processed is referred to as the target record.

First, the derived model parameter synthesizer 20 specifies the version of the common component and the version of the operation change element of the target record, and extracts the record (common component record) of a corresponding version of the common component table 61 and the record (operation change element record) of the corresponding version of the operation change element table 63 (Step S49).

Subsequently, the derived model parameter synthesizer 20 extracts all of the individualized component record or records referred to by the extracted individualized component record and the individualized component record or records referring to the version of the individualized component before change (Step S50).

Subsequently, the derived model parameter synthesizer 20 adds the value of each item of the record of the common component table to the setting (model parameter) of the machine learning model, further arranges the extracted individualized component record and the individualized component record after change in an order in which the reference destination is prioritized, and overwrites the item common to the common component record with the value of the item included in each individualized component record (Step S51).

Subsequently, the derived model parameter synthesizer 20 overwrites the item common to the model parameter of the machine learning model with the value of the operation change element record (Step S52).

Subsequently, the derived model parameter synthesizer 20 generates the machine learning model according to the model parameter of the machine learning model, and performs machine learning on the generated machine learning model using the set use data set, to add the learning result to the model parameter of the machine learning model (Step S53).

Subsequently, the derived model parameter synthesizer 20 adds a record of a set of the version of the individualized component after change, the version of the extracted common component record, and the version of the extracted operation change element record to the model component management table 60 (Step S54).

Subsequently, the model change recorder 10 performs the processing of the loop 3 (Steps S49 to S54) with each record as the processing target, and ends the derived model parameter synthesis processing when the processing of the loop 3 is ended with all the records as the processing target.

When the record has been added to the operation change element table 63 (Step S41: operation change element TB), the derived model parameter synthesizer 20 extracts a record referring to the version of the operation change element before change from the model component management table 60, extracts the common component record and the individualized component record of the version included in the extracted record, and extracts a necessary item from the common component record and the individualized component record (Step S55).

Subsequently, the derived model parameter synthesizer 20 adds the value of each item of the record of the common component table to the setting (model parameter) of the machine learning model, and overwrites the item common to the individualized component record among the items with the value of the individualized component record (Step S56).

Subsequently, the derived model parameter synthesizer 20 overwrites the item common to the model parameter of the machine learning model with the value of the operation change element record (Step S57).

Subsequently, the derived model parameter synthesizer 20 generates the machine learning model according to the model parameter of the machine learning model, and performs machine learning on the generated machine learning model using the set use data set, to add the learning result to the model parameter of the machine learning model (Step S58).

Subsequently, the derived model parameter synthesizer 20 adds a record of a set of the version of the operation change element after change, the version of the extracted common component record, and the version of the extracted individualized component record to the model component management table 60 (Step S59), and ends the derived model parameter synthesis processing.

According to the machine learning model generation support processing described above, for the machine learning model using the element before change corresponding to the changed element, it is possible to generate the machine learning model in which the element before change is changed to the element after change.

FIG. 6 is a diagram illustrating an example of generation of the machine learning model, and a specific example of the machine learning model generation support processing in the embodiment. FIG. 6 illustrates an example of a case of generating the machine learning model for detecting abnormality of facilities 1 to 3 of a certain factory.

As the application state of the machine learning model from the development to the operation of the machine learning model, there are a development stage of designing common components regardless of the facility to which the machine learning model is applied, an individualization stage of changing the machine learning model designed in the development stage according to the individual facility to which the machine learning model is applied, and a deployment and operation stage (simply referred to as an operation stage) of changing the machine learning model generated in the individualization stage according to an operation status or the like when the machine learning model is operated.

First, at the development stage, a data scientist (DS) designs the machine learning model common to the facilities 1 to 3 to which the machine learning model is applied. In the development stage, the preprocessing logic, the learning algorithm, the post-processing logic, and the like in the machine learning model are developed. Elements determined in the development stage are the common components. As a result, the machine learning model of V1 is generated.

Subsequently, in the individualization stage, a developer performs processing of updating the machine learning model to a machine learning model suitable for each facility at a site where the facility to which the machine learning model is applied is present. In the individualization stage, for each facility, the preprocessing logic, the post-processing logic, and the like determined in the development stage are changed or modified, and the parameter in the model learning parameter are changed. In the individualization stage, the component that may be changed is the individualized component. In the individualization stage, the machine learning model of the V1.1 to which the individualized component corresponding to the facility 1 is applied, the machine learning model of the V1.0 to which the individualized component corresponding to the facility 2 is applied, and the machine learning model of the V1.2 to which the individualized component corresponding to the facility 3 is applied are generated.

Subsequently, in the operation stage, the developer performs processing of updating the machine learning model to a machine learning model corresponding to the operation of each facility at the site where the facility to which the machine learning model is applied is present. In the operation stage, the data set (use data set) for learning the machine learning model is generated according to the operation of each facility, the machine learning model is learned using the use data set, and the result (learning result) for the learning is obtained. In the operation stage, the component that may be changed is the operation component. In the operation stage, the machine learning model of the V1.1.1 using the operation change element of the facility 1, the machine learning model of V1.0.1 using the operation change element corresponding to the facility 2, and the machine learning model of V1.2.1 using the operation change element corresponding to the facility 3 are generated. Thereafter, when the operation change element corresponding to the facility 3 is changed, the machine learning model of V1.2.2 using the operation change element after change is generated.

When a new common component (v2) is developed for the common component (v1) in a state where the machine learning model is generated in this manner, the model parameter of the machine learning model using the updated common component (v2) is generated for the machine learning model using the common component (v1) by performing the derived model parameter synthesis processing described above, and the corresponding machine learning model is generated. Specifically, as the machine learning model for the facility 1, the machine learning model of V2.1.1 is generated based on the common component (v2) and the individualized component and the operation change element used for the common component (v1), and similarly, as the machine learning model for the facility 2, the machine learning model of V2.0.1 is generated based on the common component (v2) and the individualized component and the operation change element used for the common component (v1), and as the machine learning model for the facility 3, the machine learning model of V2.2.2 is generated based on the common component (v2) and the individualized component and the operation change element used for the common component (v1). Note that, for the operation change element, the machine learning model is generated using the latest operation change element for the application target.

As described above, according to the derived model parameter synthesis processing described above, when the common component is updated, it is possible to generate the machine learning model using the common component after change as the common component, for a plurality of the machine learning models generated using the changed common component. Note that in the derived model parameter synthesis processing, when the individualized component is updated, it is possible to generate the machine learning model using the individualized component after change, for the machine learning model using the individualized component before change. Further, in the derived model parameter synthesis processing, when the operation change element is updated, it is possible to generate the machine learning model using the operation change element after change, for the machine learning model using the operation change element before change.

Note that the present invention is not limited to the above-described embodiment, and can be appropriately modified and implemented without departing from the gist of the present invention.

For example, in the above embodiment, the components of the machine learning model are divided into two groups of the common component and the individualized component, but the present invention is not limited thereto, and the components may be divided into three or more groups of components.

Further, in the above embodiment, a part or all of the processing performed by the CPU may be performed by a hardware circuit. Further, the program in the above embodiment may be installed from a program source. The program source may be a program distribution server or a recording medium (for example, a portable recording medium).

What is claimed is:

1. A generation support apparatus that generates configuration information for configuring a machine learning model, the generation support apparatus comprising:
a storage that stores a plurality of pieces of component information for storing a change history for each of component groups that are groups of a plurality of components for the machine learning model, and component management information for storing versions for the plurality of component groups constituting the machine learning model;
a recorder that inputs the configuration information on an updated first machine learning model, adds the change history to the component information based on the configuration information, and records a version of a component group of the updated first machine learning model in the component management information; and
a configuration information generator that generates configuration information including a component corresponding to a version of an updated component group of the updated first machine learning model, for a second machine learning model including a component group of a same version as a component group before updating of the first machine learning model.

2. The generation support apparatus according to claim 1, wherein
the storage further stores learning element information for storing a change history of a learning element that is used for learning of the machine learning model,
the component management information further stores a version of the learning element of the machine learning model,
the recorder further inputs a learning element that is used for learning of the updated first machine learning model, adds the change history to the learning element information based on the learning element, and records a version of a learning element of the updated first machine learning model in the component management information, and
the configuration information generator specifies a version of an updated learning element of the updated first machine learning model, for the second machine learning model using a learning element of a same version as the component group before updating of the first machine learning model, and includes a learning element of the specified version in the configuration information.

3. The generation support apparatus according to claim 1, wherein the plurality of component groups include a first group including a component having a high tendency to be determined in a development stage of the machine learning model, and a second group including a component having a possibility to be determined in an individualization stage of individualizing the machine learning model after the development stage according to an application target.

4. The generation support apparatus according to claim 3, wherein
the first group includes information for identifying a learning algorithm of the machine learning model, information for identifying logic used for preprocessing of the learning algorithm, information for identifying logic used for post-processing of the learning algorithm, and a parameter used in the machine learning model, and
the second group includes the information for identifying logic used for preprocessing of the learning algorithm, the information for identifying logic used for post-processing of the learning algorithm, the parameter used in the machine learning model, and information for identifying the application target of the machine learning model.

5. The generation support apparatus according to claim 1, wherein
the configuration information generator generates, for the second machine learning model, the machine learning model based on the configuration information including the component corresponding to the version of the updated component group of the updated first machine learning model.

6. The generation support apparatus according to claim 2, wherein the configuration information generator generates, for the second machine learning model, the machine learning model based on the configuration information including the component corresponding to the version of the updated component group of the updated first machine learning model, and performs learning on the generated machine learning model using the learning element.

7. The generation support apparatus according to claim 1, wherein
the plurality of component groups include same components,
the storage further stores state management information for managing an application state of the machine learning model, and
the recorder specifies an application state of the first machine learning model from the state management information, and determines the component information for storing a component included in updated configuration information for the first machine learning model based on the application state.

8. A generation support method by a generation support apparatus that generates configuration information for configuring a machine learning model, the generation support method comprising:
storing a plurality of pieces of component information for storing a change history for each of component groups that are groups of a plurality of components for the machine learning model, and component management information for storing versions for the plurality of component groups constituting the machine learning model;
inputting the configuration information including configuration for an updated first machine learning model, adding the change history to the component information based on the configuration information, and recording a version of a component group of the updated first machine learning model in the component management information; and
generating configuration information including a component corresponding to a version of an updated component group of the updated first machine learning model, for a second machine learning model including a component group of a same version as a component group before updating of the first machine learning model.

9. A generation support program that causes a computer to execute a processing to generate configuration information for configuring a machine learning model, the generation support program causing the computer to perform the steps of:
storing a plurality of pieces of component information for storing a change history for each of component groups that are groups of a plurality of components for the machine learning model, and component management information for storing versions for the plurality of component groups constituting the machine learning model;
inputting the configuration information including configuration for an updated first machine learning model, adding the change history to the component information based on the configuration information, and recording a version of a component group of the updated first machine learning model in a component management table; and
generating configuration information including a component corresponding to a version of an updated component group of the updated first machine learning model, for a second machine learning model including a component group of a same version as a component group before updating of the first machine learning model.
